(19) United States
(12) Patent Application Publication
(10) Pub. No.: US 2024/0430795 A1
(43) Pub. Date: Dec. 26, 2024

(54) METHOD FOR MANAGING AN ACTIVATION STATE OF A NODE DEVICE OF A COMMUNICATION NETWORK, CORRESPONDING APPARATUS, NODE DEVICE, SYSTEM AND COMPUTER PROGRAM

(71) Applicant: SAGEMCOM BROADBAND SAS, Bois-Colombes (FR)

(72) Inventor: Michael Thien Bao NGUYEN DINH HIEN, Bois-Colombes (FR)

(21) Appl. No.: 18/750,792

(22) Filed: Jun. 21, 2024

(30) Foreign Application Priority Data
Jun. 23, 2023 (FR) 2306596

(51) Int. Cl. H04W 52/02; H04W 48/14; H04W 48/20; H04W 76/18; H04W 84/12

(52) U.S. Cl. CPC H04W 52/0206; H04W 48/14; H04W 48/20; H04W 76/18; H04W 84/12

(57) ABSTRACT

A method for managing an activation state of a current node of a first wireless communication network that also includes a neighbor node. The current node including a first radio hosting a first access point to a core network, and a second radio hosting a second access point to a user network that is configured to connect the client device to the current node. The method includes, upon receipt of a communication request by the current node, reactivation of the other of the first and second radios, when said current node is in a partially deactivated state, and when it has been determined that a connection of the current node to the core network is required to process said communication request, reactivation of the at least one neighbor node by the current node sending a discovery request on at least one radio of said at least one neighbor node.

### REFERENCE TO A PRIORITY APPLICATION

The present application claims foreign priority to French Application No. 2306596 filed with the Intellectual Property Office of France on Jun. 23, 2023, the entire disclosure of which is incorporated herein by reference.

### TECHNICAL FIELD

The invention relates to the technical field of wireless communication networks, more particularly when they are subject to energy consumption constraints.

The invention relates in particular to a mechanism for reactivating node devices in such a wireless communication network, enabling said node devices to be restarted in a chain.

### STATE OF THE ART

Today, a user terminal is often required to access a communication service, such as the Internet, by connecting to one of the nodes of a mesh WiFi network. One of the nodes in this mesh network, called root node, enables users to access the communication service. Setting up such a mesh network requires the construction of at least two types of network, starting from each node device:

A user network. This is the network created to enable users to connect and access services such as the Internet. Only the root node has direct access to services,

A core network. This network enables the interconnection of node devices, which in turn form the elements of the mesh network. This interconnection enables each node in the mesh network to extend the user's network by retransmitting data from or to the root node. This core network also enables the exchange of control messages to manage the configuration of the various network nodes.

A mesh network node can have several WiFi radios, in order to cover the different WiFi frequency bands allowed. Typically, the user's network is deployed on all WiFi radios on each node, to provide the widest possible coverage. The core network can use all or part of the available radios to enable interconnection between the various nodes of the mesh network.

To enable a user to connect his or her device to the network, the user network periodically broadcasts a beacon in accordance with the IEEE 802.11 standard. The beacon contains, among other things, the name of the network to identify it. This information is visible to the user via a graphical interface on his or her device, showing all the networks within range with their names. Once selected, the user's terminal connects to the network and accesses the Internet. Interconnections for the core network are set up in the same way, but automatically between the various node devices, this time with the name of the core network. What's more, by following this principle, the various node devices each have the same unique user network name, so that user terminals can use this name to connect to any of the mesh network's node devices within range.

To meet the growing need for data consumption, more and more frequency bands are being used for wireless transmissions. For example, in the context of the WiFi technology defined by the IEEE 802.11 standard, the first products on the market operated in the 2.4 GHZ (11b) band, then 5 GHZ (11a) on communication channels 20 MHz wide. Subsequent generations of WiFi consolidated the use of these bands by increasing the size of communication channels: 40 MHz with generation 4 (11n/WiFi 4), 160 MHz with generation 5 (11ac/WiFi 5). Generation 6 WiFi (11ax/WiFi 6) additionally introduced the 6 GHz band with 160 MHz wide communication channels, while generation 7 (11be/WiFi 7) extends the channel width in this band to 320 MHz.

With each new generation of WiFi products, more and more radios have to be integrated on the side of an access point within the same hosting apparatus (gateway, router, etc.). In addition to the problems of coexistence among these various radios, the consumption of the whole system becomes a critical point. By default, all radios are switched on, whether or not any of them have associated client devices or user terminals.

A standard approach to reducing the power consumption of a radio is to keep it switched on but in a degraded mode (that is, several transmit/receive channels are switched off) so as to be able to detect connection requests from terminals on said radio. In the event of a positive detection, the host node device restores the radio to its nominal operating mode. The disadvantage of this approach is that, while it reduces radio consumption, it doesn't completely cut it off. In addition, reducing the number of reception channels can lead to a loss of radio sensitivity, that is, the ability to detect distant terminals. Another approach is to keep one so-called ‘primary’ radio switched on and one (or more) so-called ‘secondary’ radio(s) switched off in a gateway. A switched-off secondary radio will only be switched back on if a terminal compatible with this secondary radio is detected and associated with the primary radio.

In order to reduce the energy consumption of the device nodes of a wireless communication network, it is known to switch off the radios of each node of the mesh network when the user's network has not been used for a certain period of time. This switch-off is triggered, for example, if a connected user terminal fails to connect for a certain period of time. However, once all the radios are completely switched off, it is no longer possible to communicate through the core network, which relies on these same WiFi radios. Document US/2014/0269476 A1 describes a solution for restarting the radios of a node device upon detecting a user terminal already known and authorized to connect. On the other hand, this is a local restart, at the level of a given node, which does not allow other nodes in the mesh network to be reactivated.

Alternatively, a centralized restart can be performed via a general controller that configures each of the mesh network's node devices.

The latter solution is well suited to a homogeneous network environment, where all nodes are compatible and, for example, conform to the same version of a standard. In addition, core network radios must be kept switched on in order to keep the core network active and allow configuration control messages to be transmitted.

The present invention improves the situation.

### SUMMARY

To this end, a method is proposed for managing an activation state of a node device, called current node, of a first wireless communication network, said wireless communication network being configured to provide a communication service to a client device, said wireless communication network comprising at least one other node device, called neighbor node, said current node comprising a first radio hosting a first access point to a first wireless communication network of said current node, called core network, configured to interconnect the current node and said at least one neighbor node, and a second radio hosting a second access point to a second wireless communication network, called user network, configured to connect the client device to said current node and, via the core network, give it access to the communication service. Said current node is configured, upon expiry of a period of inactivity during which no client device has connected to said user network, to enter a partially deactivated state, comprising partial deactivation of said radios, whereby one of said first and second radios remains active. Said method comprises:
upon receipt of a communication request by the current node on one of said first and second radios, reactivation of the other radios, when said current node is in a partially deactivated state, and
when it has been determined, at least as a function of the communication request received, that reconnection of the current node to said at least one neighbor node is required to process said communication request, and following failure of reconnection of the current node to said at least one neighbor node, triggering reactivation of said at least one neighbor node by the current node sending a discovery request on at least one radio of said at least one neighbor node.

The current node device is part of a wireless communication network comprising several nodes and configured to render a communication service, for example, access to a remote network. For example, the communication service is Internet access, and one of the nodes in the wireless communication network, called gateway node, has direct access to the Internet. The current node also locally manages another wireless communication network, called user network, to which a client device, such as a user terminal, can connect, in particular to access the communication service. The core network can therefore be used to extend the user network of the current node and, in particular, to indirectly connect the user terminal to the gateway node, which has access to the Internet.

In particular, a situation is considered where the radios of the current node device are partially deactivated to meet constraints for reduction in energy consumption.

The invention proposes to trigger, following the reception of a communication request, and when at least one radio of the current node is deactivated, not only the local reactivation of the radios of the current node, but also the reconnection of the current node to at least one of its neighbor nodes. According to the invention, it triggers this reconnection only when it is required for processing the communication request. When the current node fails to reconnect to the selected neighbor node, it triggers a reactivation of this neighbor node by sending it a communication request on one of its radios that has remained active.

Thus, with the invention, not only is the state of activation of its radios managed at the level of the current node, and thus the accessibility for a user terminal to the user network of this node, but also the connection of the current node to the wireless communication network via its core network.

It is understood that, if the neighbor node itself implements the mechanism of the invention, by means of sending via the current node of a discovery request on a radio that has remained active of the said neighbor node, the latter will in turn reactivate its radios, reconnect to the current node and possibly trigger its own reconnection to other neighbor nodes if this is necessary to process the communication request received from the current node. The invention therefore makes it possible to propagate a reactivation of the radios of the network nodes step-by-step in order to achieve the necessary reconnections.

The invention is applicable to any type of communication network structure, such as a mesh or star network.

According to one aspect, the method comprises determining that a reconnection of the current node to the wireless communication network is required, at least according to a type of the communication request and a topology of the wireless communication network.

The communication request comprises an identifier for the client device that issued the request, and each node in a wireless communication network knows the topology of the network, and particularly its position relative to other nodes. Depending on the communication request received and the current node's position in the network, particularly in relation to the gateway node, it is decided whether to reconnect the current node to the wireless communication network. Reactivation at core network level is therefore only triggered when necessary.

According to another aspect, when it has been determined that a reconnection of said current node to the wireless communication network via its core network is required, the method comprises selecting at least one said neighbor node.

Depending on the type of communication request received and the current node's position in the wireless communication network topology, it may be necessary for the current node to reconnect to one of its neighbors, but not to another. One advantage is that it only reactivates neighbor nodes that need to be reactivated.

According to yet another aspect, when the communication request comprises a request to discover said network of the current node, said at least one selected neighbor node is located on said connection path from the current node to another of said core network node devices, called a gateway node, configured to provide the communication service. When the current node is not the gateway node, it selects only the neighbor node that allows it to reconnect indirectly to the gateway node.

According to another aspect, when the communication request comprises a request to configure the current node, said selection comprises the selection of all other neighbor nodes of the current node to which it is not already connected.

For example, the reconfiguration request comes from a master node, which may be the gateway node or another node. According to one or more embodiments, it is decided that all its neighbor nodes must be reactivated so that each of them is able to receive and process the reconfiguration request.

Alternatively, the current node hosts a controller that has received an initial configuration request and in response triggers the mechanism of the invention to propagate it to all nodes of the wireless communication network.

According to yet another aspect, following a connection failure to said at least one selected neighbor node, reconnection comprises checking a radio activation state of said at least one selected neighbor node and, when it has been found that the first radio of the neighbor node hosting the first core network access point is deactivated, the discovery request sent comprises a user network identifier of the neighbor node.

When the current node is disconnected from the wireless communication network and fails to reconnect to the selected neighbor node, a radio activation state of the neighbor node is checked, listening for any broadcast messages of presence on the core network. When no presence message is detected, because the neighbor node's first radio is deactivated, the current node uses the neighbor node's user network access point, whose second radio has remained active, and for which it detects a presence message. It therefore sends the discovery request to the user network access point that remains active, indicating a user network identifier in its request. In this way, the node device accesses the neighbor node via its user network, when the core network is no longer accessible. The node device thus behaves as if it were a user terminal, triggering the restart of its neighbor node and thus reconnecting to the wireless communication network.

According to another aspect, said method comprises, upon expiry of a period of inactivity during which no client device has connected to the user network of the current node, switching to a deactivated state comprising partial deactivation of said radios of the current node, at least one of said radios among the first and second radios remaining activated.

Partial deactivation of radios means switching off all radios except one. One advantage is to reduce energy consumption by the communication device when no other communication device is connected to it or has requested to connect to it for a given period of time, for example equal to 5 min, while maintaining the possibility for the current node to continue broadcasting a presence of its user network and for another device to reconnect to the communication device.

Indeed, it is not feasible to completely switch off all the radios of this communication device, as it would then no longer be possible to communicate with it, either via the user network or the core network. One advantage of keeping a radio access point activated is to maintain the possibility for a user terminal or neighbor node to communicate with the current node in order to reconnect to it if necessary. Making partial standby conditional on a lack of connection to user terminals and neighbor nodes ensures that the core network is kept fully operational for as long as it is needed.

In yet another aspect, the radio that remains activated is the second radio.

In this way, the user network access point remains activated, the node device can continue to broadcast its presence, and the user terminal can reconnect to the node device's user network.

The invention also relates to an apparatus for managing an activation state of a node device, called current node, of a first wireless communication network, configured to provide a communication service to a client device, said wireless communication network comprising at least one other node device, called neighbor node, said current node comprising a first radio hosting a first access point to a first wireless communication network of said current node, called core network, configured to interconnect the current node and said at least one neighbor node, and a second radio hosting a second access point to a second wireless communication network, called user network, configured to connect the client device to said current node and, via the core network, give it access to the communication service. Said current node is configured, upon expiry of a period of inactivity during which no client device has connected to said user network, to enter a partially deactivated state, comprising partial deactivation of said radios, whereby one of said first and second radios remains active. Said apparatus is configured to carry out:
upon receipt of a communication request by the current node on one of said first and second radios, reactivation of the other radio of the current node, when said current node is in a partially deactivated state, and when it has been determined, at least based on the received communication request, that a reconnection of the current node to said at least one neighbor node is required to process said communication request, and following a connection failure of the current node to said at least one neighbor node, triggering a reactivation of the at least one neighbor node by the current node sending a discovery request on at least one radio of said at least one neighbor node.

Advantageously, such an apparatus implements the aforementioned process for managing a node device activation state, in its various embodiments.

According to a non-limiting exemplary embodiment, the aforementioned apparatus is integrated into a node device, called current node, of a first wireless communication network, configured to provide a communication service to a client device, said wireless communication network comprising at least one other node device, called neighbor node, said current node comprising a first radio hosting at least a first access point to a first wireless communication network of said current node, called core network, configured to interconnect the current node and said at least one neighbor node, and a second radio hosting at least one second access point to a second wireless communication network, called user network, configured to connect the client device to the current node and, via the core network, give it access to the communication service.

According to another non-limiting exemplary embodiment, said node device is integrated into a communication system comprising at least two of said node devices of a first wireless communication network, configured to provide a communication service to a client device, said system comprising a client device able to connect to at least one of said node devices in order to access said communication service.

The system, the node device and the apparatus offer the same advantages as the abovementioned management method.

The invention also relates to a computer program product comprising instructions for executing the aforementioned management method.

Finally, the invention relates to a computer-readable storage medium on which the above-mentioned computer programs are recorded.

### BRIEF DESCRIPTION OF THE DRAWINGS

Further features and advantages will become apparent from the following detailed description, which may be understood with reference to the attached drawings in which:

FIG. 1 schematically shows an apparatus for managing the activation state of a node device in a wireless communication network, in its environment, according to a particular non-limiting exemplary embodiment;

FIG. 2 shows in flowchart form the steps in a process for managing an activation state of a node device in a wireless communication network, according to a particular, non-limiting exemplary embodiment;

FIG. 3 details a reconnection step to a neighbor node of the node device according to a particular non-limiting exemplary embodiment of the method for managing an activation state of a node device;

FIG. 4 schematically shows an example of step-by-step deactivation of node device in a wireless communication network;

FIG. 5 schematically shows an example of how a wireless communication network can be reactivated step-by-step when a client device requests a connection to one of its node devices, according to a particular, non-limiting exemplary embodiment;

FIG. 6 schematically shows an example of how a wireless communication network can be reactivated step-by-step when a client device requests a connection to one of its node devices, according to another non-limiting particular exemplary embodiment;

FIG. 7 schematically shows an example of implementing a step-by-step reactivation of a wireless communication network in order to apply a reconfiguration of the wireless communication network, according to yet another embodiment; and

FIG. 8 schematically shows an example of the hardware structure of an apparatus for managing the activation state of a node device in a wireless communication network, according to a particular non-limiting exemplary embodiment.

FIG. 9 shows an example of the hardware structure of an apparatus for managing the activation state of a node device in a wireless communication network.

### DESCRIPTION OF EMBODIMENTS

In the following description, identical, similar or analogous elements will be referred to by the same reference numbers. Unless otherwise indicated, the diagrams are not necessarily to scale.

The block diagrams, flowcharts and message sequence diagrams in the figures shows the architecture, functionalities and operation of systems, apparatuses, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable dataprocessing system can be used for the implementation. An appropriate data-processing system or device comprises for example a combination of software code and circuits, such as a processor, controller or other circuit suitable for executing the software code. When the software code is executed, the processor or controller prompts the system or apparatus to implement all or part of the functionalities of the blocks and/or steps of the processes or methods according to the exemplary embodiments. The software code can be stored in a memory or a readable medium accessible directly or via another module by the processor or controller.

The following exemplary embodiments are non-limiting and are based on networks that comply with the 802.11 family of standards of the Institute of Electrical and Electronics Engineers (IEEE), or so-called “WiFi” networks. They apply to both home and corporate wireless networks.

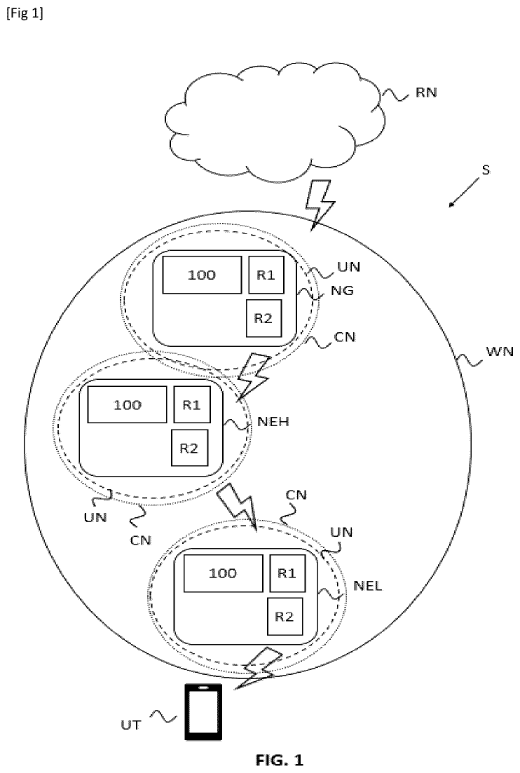

In conjunction with FIG. 1, a system S for managing an activation state of a wireless communication network WN is presented, according to one or more particular non-limiting exemplary embodiments. In this example, the network WN is a mesh network comprising three node devices NG, NEH and NEL. Each of the nodes NG, NEH and NEL is equipped with at least a first radio R1 hosting at least a first access point to a first wireless network called core network CN (or sometimes also referred to as the backhaul network), designed to enable interconnection of the node device of the network WN, and a second radio R2 hosting at least a second access point to a second wireless network called user network UN (or sometimes also referred to as the fronthaul network), designed to connect client devices, such as user terminals UT. Here, it relates to a mobile terminal such as a smartphone, but it can relate to any user terminal equipped with suitable wireless communication means, for example a laptop, tablet, connected object, etc. It should be noted that the user network UN is generally deployed on each of the node device's WiFi radios, in order to offer user terminals the widest possible coverage. It should also be noted that the core network CN also enables node devices to exchange control messages, notably with a view to managing their configuration. For example, the network WN complies with the IEEE802.11 Easy Mesh standard, which defines the use of the IEEE1905 communication protocol between different wireless access points, for example hosted by communication devices produced by different manufacturers and forming the nodes of a WiFi or Ethernet mesh network (or a combination of both). In other words, an EasyMesh-certified communications device is able to communicate with any other EasyMesh-certified communications device using a set of messages defined in the IEEE1905 protocol.

According to this standard, a controller is configured to manage the configuration of a network node device by sending control messages to agents that execute the controller's commands. The controller and its agents can be hosted on network nodes WN.

It is understood that the core network CN enables each node device in the mesh network to extend its user network UN by retransmitting data transmitted by a user terminal that has connected to its user network to another node in the wireless communication network WN. In particular, it is assumed here that the wireless communication network WN is configured to render one or more communication services to the user terminal UT. For example, the communication service in question is access to a remote network RN, such as the Internet. In another example, the communication service is a service for accessing a Network Attached Storage (WN) unit. It can also be an authentication service attached to the network WN. In yet another example, the communication service is a service for accessing a printing unit associated with the network WN. In yet another example, the communication service is a service enabling access to dedicated resources such as distributed computing resources, which may be available in the network WN or in a remote network. In yet another example, the communication service is a service enabling the user terminal to interact with another terminal associated with the network WN. More generally, the term “communication service” will be associated with different types of services accessible and/or associated with the network WN.

Note that the user network and the core network of each node in the network WN can each use different or identical network identifiers, such as SSIDs (Service Set Identifiers). For simplicity's sake, we'll assume that all user networks UN use the same network ID SSID-UN, and all core networks CN use the same network ID SSID-CN. It should also be noted that a network node WN can manage local networks other than the user network UN. For simplicity's sake, the term “core network” will also be used here to refer to the wireless communication network WN and the fact that the nodes of this wireless communication network WN connect and communicate with each other via their respective core networks.

In the network WN, the node device NG is considered in particular, known as the root node or gateway node, which is the network node WN configured to provide the communication service(s) offered by the network WN. In a non-limiting manner, the example shown in FIG. 1 is that of a gateway node NG with access to the remote network RN, and the communication service includes Internet access. In the example shown in FIG. 1, it relates to a home gateway or an enterprise gateway.

In the following, however, the term “gateway node” will be used more broadly to refer to the node in the wireless communication network WN that provides the communication service(s) offered to user terminals by the network WN, whether they are hosted in the local network WN or in the remote network RN.

It is understood that in such a communication network WN, thanks to the core network CN, the user terminal UT can connect to any of the node devices NEL, NEH and NG to access the communication service(s). The other two nodes are extension nodes of the mesh network, the node NEH, or high extension node, is an intermediate node able to interconnect with both the root node NG and node NEL, or low extension node, which is only able to connect to its single neighbor NEH.

It is assumed that, according to some embodiments, a node device is able to deactivate at least part of its radios when it has been verified that no client device, user terminal or neighbor node, has connected to it for a given period of time, in order to save its energy consumption. Some embodiments are found in this particular context of a state of partial deactivation of the radios of a node device in the communication network WN.

In the example shown in FIG. 1, each of the node devices of the wireless communication network WN comprises an apparatus 100 for managing an activation state of a node device according to one embodiment. Such an apparatus is configured to implement:
upon detection of a communication event, when one of the first and second node device radios was in a deactivated state, reactivation of this radio, and
when it has been determined, at least based on the communication request received, that a reconnection of the current node to the core network is required to process said communication request, and following a connection failure of the current node to said at least one neighbor node, the sending by the current node of a discovery request on a radio remaining active of said at least one neighbor node.

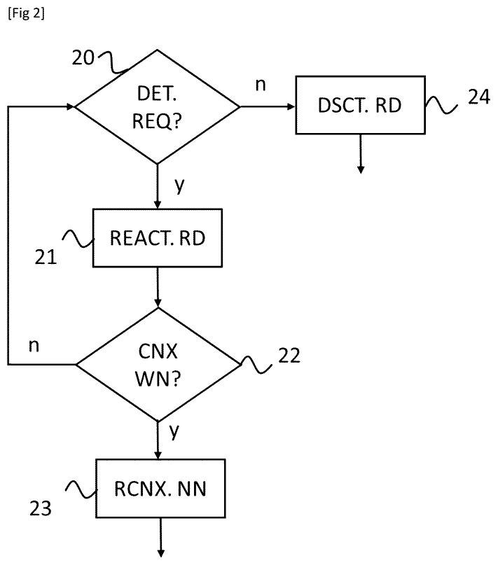

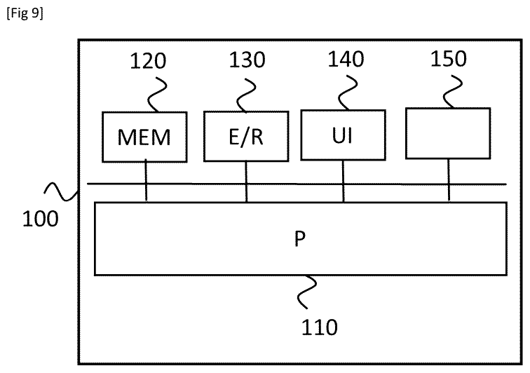

The apparatus 100 thus implements a method for managing an activation state of a node device of a wireless communication network, which will be presented below in relation to FIG. 2. The apparatus 100 can be implemented in a variety of ways. An example of the hardware structure of the apparatus 100 will be described below in relation to FIG. 9.

Now presented in conjunction with FIG. 2, is a method for managing an activation state of a node device of a wireless communication network according to one or more embodiments. A node device is considered here, called current node, which can be any node device in a wireless communication network comprising several nodes, for example any of the node devices NG, NEH, NEL in the example shown in FIG. 1.

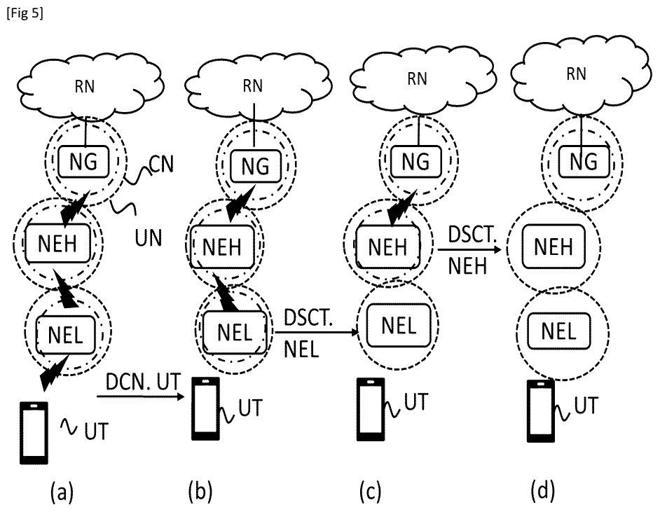

It is assumed here that the current node's radios are partially disabled. For example, only the second radio is active, so only the user network UN of the current node is accessible. The current node is therefore disconnected from the core network CN. For the other nodes in the wireless communication network WN, it is assumed that they are either partially deactivated, according to the same assumption, or in an activated state. An example of partial deactivation of the wireless communication network will be described in more detail in connection with FIG. 5.

It should also be noted that the method now described also applies to a node in active mode, where all radios are operating nominally. An example will be detailed in connection with FIG. 8.

At 20, a communication request is received by the current node. This is, for example, a user network UT discovery request received from the user terminal UT on the current node's second radio, which has remained at least partially active. This request conforms, for example, to a standardized communication protocol in use, such as the IEEE802.11 protocol, and comprises a “Probe Request” type of message. Typically, a user terminal sends this type of message in order to connect to the wireless communication network WN and then access the communication service. Note that this discovery request can also come from another node in the wireless communication network, adjacent to the current node.

According to another non-limiting example, this is a control request from another node device in the network WN. For example, it comprises a request to update or reconfigure the wireless communication network. It is usually originally issued by the gateway node in FIG. 1 in response to a configuration order that may originate outside the network WN. For example, it was received from a remote device via its direct connection to the remote network RN. Alternatively, it can also come from a controller located anywhere in the network WN, for example on a node in the network WN other than the gateway node. According to the IEEE802.11 EasyMesh standard, for example, such a controller is configured to run a management program of the network WN and transmit commands to agents that execute them. In theory, the topology of the network WN is not linked to that of the links between the controller and its agents. In practice, however, the controller is usually implemented on the gateway node and the agents on other nodes WN.

For example, this update request complies with the IEEE802.11 Easy Mesh protocol. Note that to receive this control request, the current node must be in a state in which its first radio is activated. This case will be discussed in detail with FIG. 8.

At 21, the current node is commanded to reactivate its radio, which was in a deactivated state. In this example, it is the first radio. Therefore, this is a local reactivation.

At 22, it is checked whether at least one given condition for reconnection of the current node to the core network CN is satisfied.

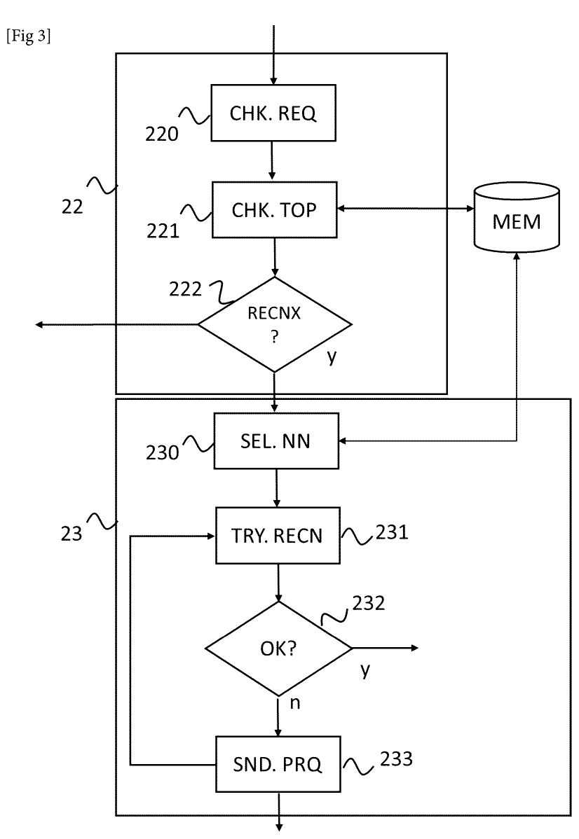

We assume here that this is the case. At 23, the current node is commanded to reconnect to at least one of its neighbor nodes. Steps 22 and 23 are described below in relation to FIG. 3.

If, on the other hand, the condition for reconnecting the current node to the core network CN is not met, because the current node is able to process the communication request received, we return to step 20 and wait for a new communication request.

More detail is now provided, in relation to FIG. 3, about the verification step 22 that at least one condition for reconnection to the core network CN has been met, according to a nonlimiting exemplary embodiment. At 230, a type of communication request received and an identifier of the communication device source of the request are obtained. For example, it involves determining whether the request received is a discovery request from the current node's user network UN. At 231, a topology is obtained of the core network and, more precisely, a place for the current node in the core network. It is assumed that the current node is able to obtain information relating to this topology, for example from a memory MEM accessible to the apparatus 100, which may or may not be integrated in this apparatus. It can also obtain them via messages, called beacons, transmitted by its neighbor nodes. It knows, for example, whether a neighbor node connects it to the gateway node or not.

Using the information obtained, it is then determined at 222 whether or not to reconnect the current node to the core network. For example, if the communication request received is a discovery request from the current node's user network, and the current node is the gateway node, it is decided that no reconnection to the core network is required. In fact, since it is the user network that provides the communication service (for example, it has direct access to the Internet), all it has to do is reconnect the user terminal to its user network. The reactivation of its local radios is therefore sufficient for it to process the communication request. In this case, a return is made to step 20.

In another example, it is determined that the current node is not the gateway node NG and the communication request received is a user network discovery request. In every case, regardless of the source of the discovery request received, it is decided that a reconnection of the current node to the core network is necessary.

Reconnection step 23 is therefore carried out. At 230, at least one neighbor node to which the current node must reconnect is selected. Several selection logics can be implemented.

In one or more exemplary embodiments, the current node must re-establish its connection to the core network in the direction of the gateway node. It therefore selects a neighbor node located on the connection path to the root node. Depending on the topology of the core network, there may be several. In the example shown in FIG. 1, there is no more than one. For example, if the current node is the low extension node NEH, the selected neighbor node is the high extension node NEH.

If there are several neighbor nodes, just one can be selected, or all of them. For example, the selected neighbor node is the one to which it was previously connected. For example, this information is obtained from the memory MEM.

At 231, the node is instructed to attempt to reconnect to the selected neighbor node. To do this, the current node listens to the radios of the selected neighbor node to determine whether the radio hosting the core network access point has remained active. If so, it sends a discovery request to connect directly to the neighbor node's core network. If 232 is successful, it reconnects to the neighbor node and processes the communication request. If this fails, it sends a discovery request PRQ to the neighbor node's second active radio. This is the one hosting the access point to the neighbor node's user network UN. It therefore behaves like a user terminal client device, trying to reach its neighbor node.

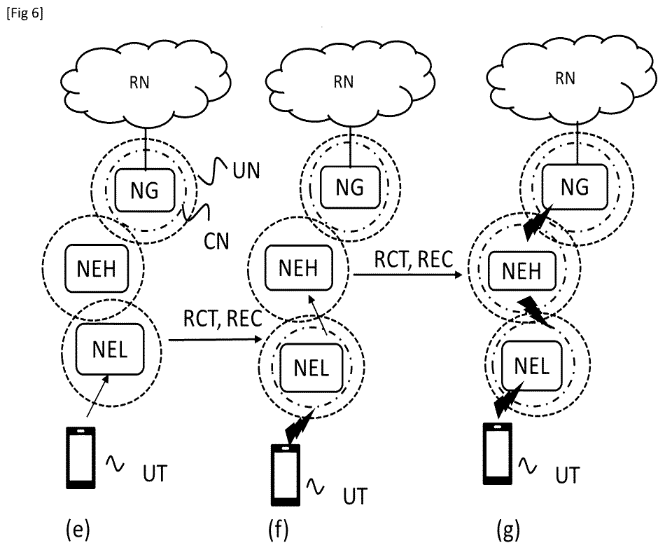

It is understood that the reception by the neighbor node in question of this discovery request PRQ, provided that it implements the process for managing an activation state of a node device according to the invention that has just been described, will trigger the same mechanism upon reception of the discovery request sent by the current node, which will make it possible to propagate step-by-step the reconnection between the nodes of the core network CN. Examples of step-by-step propagation are described below in relation to FIGS. 6-8

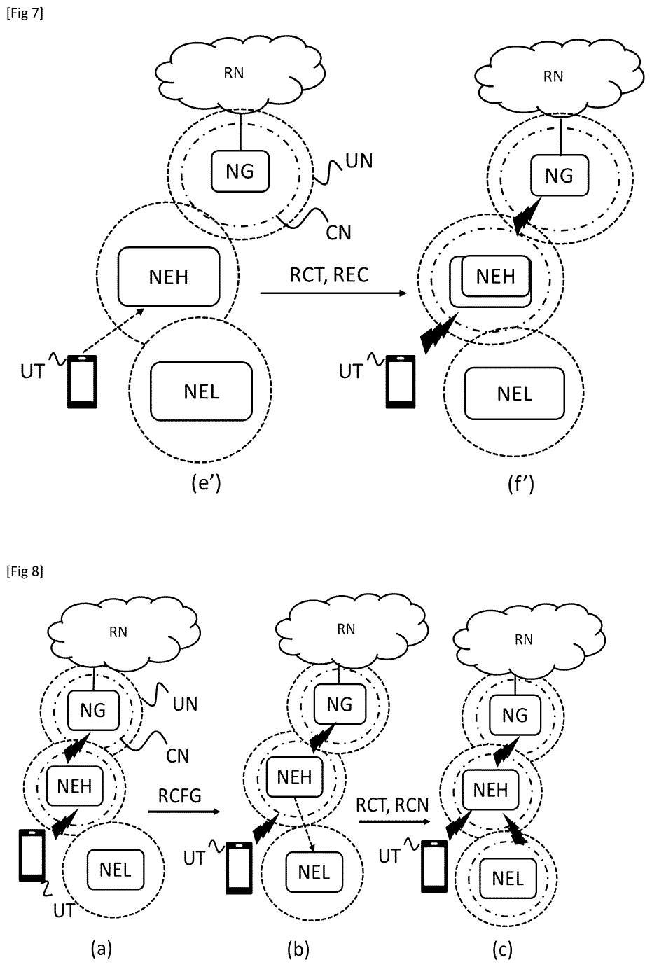

Returning to step 230, another example is now considered, in which the current node is the high extension node NEH of the node. According to embodiments, it is decided that a reconnection to the core network is required, and the selected neighbor node is the gateway node NG. The low extension node NEL is not used, as it does not provide access to the communication service. An example of this type will be described below in relation to FIGS. 6-7

Returning to step 20, when no communication request is received by the current node for a given period of time, for example, 5 min, and it has been verified that it is not connected to any client device, user terminal or neighbor node, the current node at 24 is commanded to partially deactivate its radios.

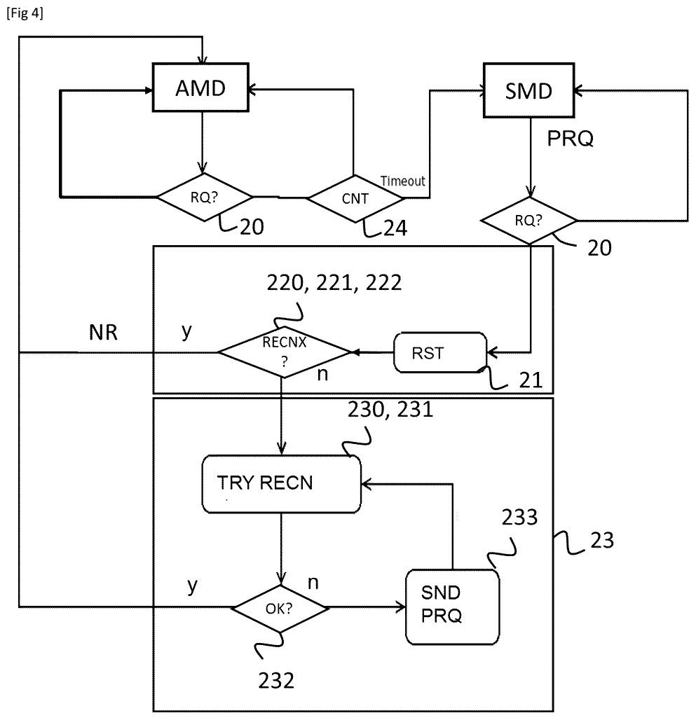

In conjunction with FIG. 4, an example is now described of an algorithm for switching the current node from an active mode to a standby mode by implementing the method for managing an activation state of a node in a wireless communication network according to embodiments. For example, this algorithm is implemented by the apparatus 100. For the sake of clarity, the steps/sub-steps of the management method are designated by the same references as those used previously in connection with FIGS. 2 and 3.

The starting state of a current node is the active mode AMD. Active mode refers to a state of the current node wherein all its radios are active and therefore operational.

In this active mode, it is verified at 20 whether any communication devices are connected to the current node in order to determine whether the current node can go into standby mode. If connections are in progress, nothing happens. If no communication device is connected or is in the process of establishing a connection with the current node, a counter or timer is started. If a new connection request is received before a given radio inactivity timeout expires, the timer is deactivated. Otherwise, once the time has expired at 24, the standby mode SMD is activated. The radio inactivity delay represents a period of radio inactivity for the current node. For example, it is set at 5 min, which is an acceptable compromise that avoids untimely and too frequent deactivations due to simple disturbances, while contributing to a significant reduction in the current node's energy consumption. These disturbances may be caused by an electromagnetic signal generated by an electrical device disrupting radio communication. For example, a microwave oven can interfere with a WiFi radio on the 2.4 GHz frequency band. They can also be due to the appearance of an obstacle between the current node and a client device, for example the body of a person who physically passes between the two communication devices, or a wall, following the movement of a user terminal. It is understood that these disturbances can cause temporary disconnections, but this does not mean that the current node has to be put on standby.

A radio inactivity timeout value that is too short could prevent devices from connecting or be triggered too often for simple disturbances. For example, it can be set to run for 5 minutes. After these 5 minutes, if no client device has connected to the current node, the current node can be considered inactive, in which case “standby” is acceptable. In other examples, depending on the environment under consideration, in particular in relation to the number of terminals or stations usually connected, this radio inactivity delay can be configured to last of the order of a minute (when a small number of stations are likely to want to connect) or to last more than 5 minutes (when a larger number of stations are likely to want to connect). According to some embodiments, this standby mode corresponds to a state of partial deactivation of the current node's radios.

According to some embodiments, standby mode is a state of partial deactivation of the current node's radios. For example, at least one WiFi access point is kept operational. In this way, the current node remains accessible to any communication device wishing to connect to it. For example, the access point to be kept operational can be selected on the basis of various criteria. For example, it is the one that covers the most communications devices, or the one that was last used before the standby mode, or the one previously chosen as such by a user.

Standby or partial deactivation of the current node's radios can also include switching the radio left active to a degraded operating mode. For example, the number of active antennas and/or the transmission power of a given antenna is reduced, or traffic acceleration paths are switched off, etc. The radio itself may operate in a degraded state (for example, reduction in the number of active antennas, reduction in transmission power, switching off of traffic acceleration paths, etc.). It is understood that this partial standby is intended to achieve a dual objective, that of reducing the energy consumption of the current node when it is in a state of inactivity while maintaining the possibility of continuing to broadcast the presence of at least one network of the current node and to detect any connection request from a user terminal to this network.

With reference to a node device in FIG. 1 comprising two radios, it is also understood that this partial standby will lead to one of the two radios being switched off. According to one exemplary embodiment of the invention, the first radio R1 hosting the core network access point is switched off and the second radio R2 hosting the user network access point is kept active, at least in a degraded mode, so that a user terminal can continue to access the user network. It is noted that a part (for example, a branch) of the core network is cut, which remains an acceptable situation insofar as it is no longer in use.

In one example, we assume that the second radio is the only one left active. Once installed in standby mode SMD, the current node continues to broadcast the presence of the user network UN, periodically transmitting a beacon signal on its radio that remains active, comprising an identifier of the corresponding network, in a manner known per se. For example, the network identifier includes an SSID (Service Set Identifier). It continues to listen to this radio at 20 to detect any connection events.

If, following reception of this beacon signal, a communication device, such as a user terminal, wishes to connect to the network of the current node identified by the SSID, it sends a discovery request, such as a probe request, including this SSID. It is received at 20 by the current node. It is then verified that it includes the identifier of its network (in this case, its user network UN). If the network ID indicated does not correspond to that of the access point which has remained active, nothing happens and the request is ignored. The SSID network identifier therefore acts as a filter. If there is a match, it is decided that a communication device wishes to connect, which triggers local reactivation of the current node's radios at 21. For example, such reactivation includes reactivating the first radio and switching the second radio from a degraded mode to a fully active mode. In other words, previously switched-off antennas are switched back on, transmission power is restored to a nominal operating level and traffic acceleration paths are re-established.

This restart is carried out locally, that is, the procedure for restarting the current node's access points, its own connection to the rest of the core network, and any other user networks it manages locally, is triggered locally at the current node in some embodiments.

Reconnection to the core network then takes place if necessary, when at least one reconnection condition is met. As described above, this condition is checked at 22. According to one embodiment, it takes into account a type of communication request received (discovery request or configuration request, for example) obtained at 220 and relies on knowledge of the network topology, obtained at 221, for example from a memory MEM accessible to the apparatus 100, and in particular the place of the current node in the network WN. If it is decided at 222 that the node must reconnect to the core network CN, step 23 is triggered. At least one neighbor node is selected at 230, and the current node attempts to connect to its core network at 231. In the event of a failure at 232, the current node is commanded to send a discovery request at 233 to the selected neighbor node(s) to trigger its reactivation according to the method of the invention just described.

Once access to wireless network services has been restored, the current node returns to active mode AMD.

In connection with FIG. 5, according to one embodiment an example of switching to standby of the nodes of a wireless communication network will now be described.

In this and the following examples, the wireless communication network is considered, shown in FIG. 1 with a mesh network structure and comprising the following device nodes:

A network gateway NG connected to the Internet and providing two networks, one user and the other core, broadcast on two radios. It is also called a root node, and

Two WLAN (WiFi over LAN) extension nodes, NEH and NEL, configured to connect to the core network, and broadcasting both the user network UN and the core network CN on two radios.

In FIG. 5 and following (6 to 8), UN and CN network broadcasts on different radios are represented by a dotted, segmented halo. The WiFi connection between two wireless communication devices (user terminal and/or node device) is represented by a lightning bolt linking the two devices in question. A cell phone icon represents a user terminal UT. An arrow with a dotted line represents a discovery or probe request sent by a communication device (user terminal or wireless communication node WN) in the direction of a network node WN. A horizontal solid arrow represents the transition between two states (active mode AMD and standby mode SMD). The solid line between the gateway node NG and the Internet network RN represents the link between the user's network provided by the network WN and the Internet.

In conjunction with FIG. 5, an initial state (a) is considered of the network WN in which a user terminal is connected to the low extension node NEL, which in turn is connected to the high extension node NEH, the latter being directly connected to the gateway node NG. Thanks to this succession of connections, the user terminal UT can access the services offered by the network WN, such as the Internet connection service, or a communication service with other entities associated with said network WN.

The WN is then considered to move from state (a) to a state (b) that is triggered by a disconnection of the user terminal from the user network UN of the low extension node NEL. The user terminal UT no longer has access to the network WN.

The transition from state (b) to state (c) is triggered by the low extension node, which switches to standby mode SMD after an inactivity timeout. According to the invention, it has therefore deactivated some of its radios, leaving just one, possibly in degraded mode. For example, it involves the radio hosting the user network UN access point. The low extension node NEL therefore disconnects from the core network of the high extension node NEH.

The transition from state (c) to state (d) is triggered by the high extension node NEH. After a certain period of inactivity, this node in turn goes into standby mode SMD, resulting in its disconnection from the gateway node NG. In state (d), the three nodes NEL, NEH and NG are disconnected from one another. Note, however, that the gateway node NG remains connected to the remote network RN. In fact, this connection is not linked to the state of the core network CN, since the gateway node, which in the example shown in FIG. 1, is a home or corporate gateway, is usually connected to the remote (Internet) network RN via an xDSL (Digital Subscriber Line) or GPON (Gigabit Capable Passive Optical Network) fiber link.

It can be seen that in the particular example of the mesh network shown in FIG. 5, which features a tree topology whose root is the network gateway NG, connections to client devices start at the nodes closest to the root, then proceed throughout the tree to the leaves. Conversely, deactivation logic is first triggered at the leaf node level, before working its way down the tree, eventually to the root.

In relation to FIG. 6, an example of reactivating the nodes of a wireless communication network according to one embodiment of the invention is now presented. FIG. 6 takes as starting state the state (d) from FIG. 5.

A state (e) is triggered by the detection of a communication event, which corresponds to a connection request from the user to the user network of the low extension node NEL whose access point has remained active. To do this, the user terminal UT has issued a discovery or probe request for the user's network UN, including an SSID identifier for this network. Receipt of this discovery request triggers implementation of the wireless communication network reactivation mechanism previously described at the low extension node NEL. The latter reactivates its radios locally and re-establishes its user and core networks.

The transition from state (e) to state (f) is triggered by an attempt to reconnect the low extension node NEL to its neighbor, the high extension node NEH. As the high extension node has deactivated its radio hosting the core network CN access point, the low extension NEH node sends a discovery request to the user network in order to trigger the reactivation mechanism according to the invention at the level of its neighbor. In addition, because the low extension node NEL reactivated its radio hosting the user network access point, the user terminal was able to connect to it.

The transition to state (g) is triggered by the exit from standby mode of the high extension node NEH, which in turn reactivates its radios and re-establishes its user and core networks. In this way, the low extension node NEL can reconnect to the high-extension node NEH, which in turn reconnects to the gateway node NG. Now that all links between WN nodes have been re-established, the user terminal gains access to the Internet. In conjunction with FIG. 7, another example of reactivating the wireless communication network, is now presented, which is a variant of the previous example.

FIG. 4 takes the state (d) in FIG. 5 as the starting state. In this example, the user terminal UT seeks to connect directly to the high extension node NEH. One possible reason is that it is within radio range of this node rather than the low extension node NEL. The state (e′) shows the attempted connection of the user terminal UT to the high extension node NEH. It includes the transmission by the user terminal UT of a discovery request indicating the SSID network identifier of the user network UN. On receipt, the high extension node NEH triggers a local reactivation of its radios, determining that it needs to reconnect to the core network CN.

The state (f′) is triggered when the high extension node NEH exits standby mode. As the gateway node has kept its radios active, the high extension node NEH can directly reconnect to the gateway node. In addition, the user terminal receives a response from the high extension node NEH to its discovery request and connects to it. This establishes the connection chain between the user terminal UT and the gateway node NG, giving the user terminal UT access to the Internet.

It can be seen that in this example, the low-level extension node NEL does not come out of standby mode, since this is not necessary to provide the communication service to the user terminal UT. One advantage is to optimize the energy consumption of the wireless communication network WN.

In conjunction with FIG. 8, yet another example is presented of how to implement the invention. The starting state (a) is the state (b) shown in FIG. 7. As a reminder, all nodes are returned to active mode AMD, except for the low extension node NEL, which remained in standby mode SMD. In particular, this method enables the low-level extension node NEL to be restarted.

In this example, it is assumed that the gateway node also acts as the controller of a network configuration. For example, the gateway node NG itself has received an update or configuration request, for example from the remote network RN. To put it into effect, the gateway node NG tries to reconnect to its neighbor node(s). When it succeeds, it transmits the configuration request. If it fails to do so, it implements the network reactivation mechanism according to one or more of the modes just described, by sending them a discovery request on their radio that has remained active. In conjunction with FIG. 8, in state (a), all nodes in the network are in active mode AMD, except for the low extension node NEL. The gateway node NG sends an update/configuration request to its neighbor, the high extension node NEH. The configuration can be applied directly to the high extension node NEH, as it is already connected to the gateway node NG. Furthermore, this update/configuration request received by the high extension node NEH is treated as a communication event that triggers the reactivation mechanism according to the invention. In this case, local reactivation of the radios of the high extension node NEH is not required, as it is already in active mode. As the high extension node NEH is already in active mode AMD, its radios are already active. On the other hand, the receipt of an update/reconfiguration request is interpreted by the method according to the invention as a condition for reconnecting the high extension node to all its neighbor nodes. The high extension node NEH tries to reconnect to the low extension node NEL. Because the radio hosting the access point of the low extension node NEL to the core network CN of the low extension node NEL is deactivated, the high extension node NEH sends a core network discovery request to trigger the neighbor node NEL to implement the reactivation mechanism described above.

In state (b), the low extension node NEL receives the discovery request from the high extension node NEH on its user network UN, which triggers the local reactivation of its radios. In this case, as it is located at the end of the branch, local reactivation of its own radios is sufficient. It has no neighbor other than the high extension node NEH to reconnect to, and thus to propagate a radio reactivation trigger to.

In state (c), the low extension node NEL reconnects to the core network CN. The high extension node NEH can then forward the update/reconfiguration request to the high extension node NEH for execution.

Thus, the reactivation mechanism according to one or more of the above-described embodiments enables the gateway node to apply a new network configuration to all nodes in the wireless communication network, even those in standby mode SMD.

Optionally, the low extension node NEL can return to standby mode once its configuration has been updated, thus returning to the initial state (a) shown in FIG. 8.

The functions, steps and methods described herein can be implemented by software (for example, via software on one or more processors, for execution on a general-purpose or special-purpose computer) and/or implemented by hardware (for example, one or more electronic circuits, and/or any other hardware component).

The present description thus relates to a computer program or software, capable of being executed by a host apparatus (for example, the apparatus 100), by means of one or more data processors, this program/software having instructions for causing said host apparatus to execute all or part of the steps of one or more of the methods described herein. These instructions are intended to be stored in a memory of the host apparatus, loaded and then executed by one or more processors of this host apparatus so as to cause this host apparatus to execute the method in question.

This software/program may be coded using any programming language, and may be in the form of source code, object code, or intermediate code between source code and object code, such as in a partially compiled form, or in any other desirable form. The host apparatus can be implemented by one or more physically separate machines. The host apparatus may have the overall architecture of a computer, including the components of such an architecture: data memory (ies), processor(s), communication bus(es), hardware interface(s) for connecting this host apparatus to a network or other device, user interface(s), etc.

In one embodiment, some or all of the steps of the programming method or other method described in this document are implemented by a programming apparatus having means for implementing those steps of that method.

These means may comprise software means (for example instructions of one or more program components) and/or hardware means (for example data memory (ies), processor(s), communication bus, hardware interface(s), etc.).

These means may comprise, for example, one or more circuits configured to execute one or more or all of the steps of one of the methods described herein. These means may comprise, for example, at least one processor and at least one memory comprising program instructions configured to, when executed by the processor, cause the apparatus to perform one, more or all of the steps of one of the processes described herein.

FIG. 9 shows an example of the hardware structure of an apparatus 100 for managing the activation state of a node device in a wireless communication network according to the invention. In this example, the apparatus 100 is configured to implement all the steps of the method of managing an activation state of a node device described in the present document. Alternatively, it could implement only some of these steps.

In conjunction with FIG. 9, the apparatus 100 comprises at least one processor 110 and at least one memory 120. The apparatus 100 may also include one or more communication interfaces. In this example, the apparatus 100 comprises network interfaces 130 (for example, network interfaces for wired/wireless network access, including an Ethernet interface, WIFI interface, etc.) connected to the processor 110 and configured to communicate via one or more wired/wireless communication links and user interfaces 140 (for example, keyboard, mouse, display screen, etc.) connected to the processor. The apparatus 100 may also include one or more media players 150 for reading a computer-readable storage medium (for example, a digital storage disc (CD-ROM, DVD, Blue Ray, etc.), a USB stick, etc.). The processor 110 is connected to each of the other aforementioned components in order to control their operation.

The memory 120 may comprise random access memory (RAM), cache memory, non-volatile memory, backup memory (for example, programmable or flash memories), read-only memory (ROM), hard disk drive (HDD), solid-state drive (SSD) or any combination thereof. The ROM of memory 120 can be configured to store, among other things, an operating system of the apparatus 100 and/or one or more computer program codes of one or more software applications. The RAM of memory 120 can be used by the processor 110 for temporary data storage.

The processor 110 can be configured to store, read, load, execute and/or otherwise process instructions stored in a computer-readable storage medium and/or in memory 120 so that, when the instructions are executed by the processor, the apparatus 100 performs one or more or all of the steps of the construction method, respectively diagnostic, described herein. Means implementing a function or a set of functions may also refer in this document to a software component, a hardware component or a set of hardware and/or software components, able to implement the function or the set of functions, as described below for the means concerned.

The present description also relates to an information medium readable by a data processor, and having instructions of a program as mentioned above.

The information medium may be any hardware means, entity or device, capable of storing the instructions of a program as mentioned above. Usable program storage media include ROM or RAM memories, magnetic storage media such as magnetic disks and tapes, hard drives or optically readable digital data storage media, etc., or any combination thereof.

In some cases, the computer-readable storage medium is not transitory. In other cases, the information medium may be a transient medium (for example, a carrier wave) for the transmission of a signal (electromagnetic, electrical, radio or optical signal) carrying program instructions. This signal can be conveyed via an appropriate transmission medium, wired or wireless: electrical or optical cable, radio or infrared link, or by other means.

One embodiment also relates to a computer program product comprising a computer-readable storage medium having program instructions stored thereon, the program instructions being configured to cause the host apparatus (for example a computer) to implement some or all of the steps of one or more of the methods described herein when the program instructions are executed by one or several processors and/or one or more programmable hardware components of the host apparatus.

The embodiments just presented are not limited to the particular example of a mesh network just presented and are applicable in other use cases, such as, for example:
a wireless communication network structured according to another type of mesh or a star-structured wireless communication network in which several WLAN extension nodes are connected to a single node (for example, the gateway node or other extension node). The mechanisms just described apply in the same way. A node must, however, wait until all nodes or devices connected to it are no longer connected before it can switch to standby,
a heterogeneous network, wherein some nodes implement the invention and others do not. In this case, an extension node that does not implement the invention's solution continues to go into standby and reactivate itself following its own logic, whereas a node that implements the invention will not go into standby mode as long as one of its neighbors remains connected to it. In both cases, the coherence of the network is preserved.

The above-mentioned methods, and their variants, each offer a number of advantages. They enable the control of how the radios of node devices are switched off, as well as defining how they will be switched back on, so that access to services can be restored when network users wish to reconnect, and an update can be applied to all nodes when required. The solutions offered in these embodiments work with standard IEEE 802.11 messages and enable each node in the wireless communication network to manage its own standby/sleep mode, without the need for centralized management by a controller, such as a master node, which would command agents to switch some of their radios off or on according to a centralized logic. Finally, these solutions ensure network consistency between a current node implementing the solution and other nodes not implementing it. In fact, the following can be considered:
either another node of the network that does not implement any standbymethod. In this case, the current node does not need to implement the reactivation mechanism just described, since the other node never goes into standby mode,
or another node that would implement a different standby and/or reactivation method than the one just described. In this case, this other node, if it has not deactivated all its radios, will receive the discovery request sent by the current node, but will not trigger the step-by-step core network reactivation mechanism just described, but the coherence of the network and each node's own mode of operation will be preserved.

The invention claimed is:

1. A method for managing an activation state of a node device, called current node, of a wireless communication network (WN), said wireless communication network (WN) being configured to provide a communication service to a client device, said wireless communication network (WN) comprising at least one other node device, called neighbor node, said current node comprising a first radio hosting a first access point to a first wireless communication network, called core (CN) of the current node, configured to interconnect the current node and said at least one neighbor node, and a second radio hosting a second access point to a second wireless communication network, called user network (UN), of the current node, configured to connect the client device to said current node and, via the core network (CN), give it access to said communication service characterized in that, said current node being configured, upon expiry of a period of inactivity during which no client device has connected to said user network (UN), to enter a partially deactivated state, comprising a partial deactivation of said radios, whereby one of said first and second radios remains active, said method comprises:
upon receipt of a communication request by the current node on one of said first and second radios, reactivation of the other radio of the current node, when said current node is in the partially deactivated state, and
when it has been determined, at least as a function of the received communication request, that reconnection of the current node to said at least one neighbor node is required to process said communication request, and following failure of reconnection of the current node to said at least one neighbor node, triggering reactivation of the at least one neighbor node by the current node sending a discovery request on at least one radio of said at least one neighbor node.

2. The method of managing an activation state of a node device according to claim 1, characterized in that it comprises determining that a reconnection of the current node to said at least one neighbor node is required, at least as a function of a type of the communication request, and of a topology of the wireless communication network.

3. The method of managing an activation state of a node device according to claim 1, characterized in that, when it has been determined that a connection of said current node to the wireless communication network (WN) is required, the method comprises selecting at least one said neighbor node and the discovery request is sent to said at least one selected neighbor node.

4. The method of managing an activation state of a node device according to claim 3, characterized in that, when the communication request comprises a request for discovery of said network of the current node, said at least one selected neighbor node is located on said connection path from the current node to another of said node devices of the wireless communication network (WN), called gateway node, configured to provide the communication service.

5. The method of managing an activation state of a node device according to claim 3, characterized in that when the communication request comprises a request for configuration of the current node, said selection comprises the selection of all other nodes neighboring the current node to which it is not already connected.

6. The method of managing an activation state of a node device according to claim 1, characterized in that reconnection comprises, following a connection failure to said at least one selected neighbor node, verification of an activation state of radios of said at least one selected neighbor node, and in that, when it has been ascertained that the first radio of the neighbor node hosting the first access point to the core network is deactivated, the discovery request sent comprises an identifier of the user network of the neighbor node.

7. The method of managing an activation state of at least one radio of a node device according to claim 6, characterized in that the radio which remains activated is the second radio and the current node is disconnected from said at least one neighbor node.

8. An apparatus for managing an activation state of a node device, called current node, of a wireless communication network (WN), configured to provide a communication service to a client device, said wireless communication network (WN) comprising at least one other node device, called neighbor node, said current node comprising a first radio hosting a first access point to a first wireless communication network, called core network (CN) of the current node, configured to interconnect said current node and said at least one neighbor node, and a second radio hosting a second access point to a second wireless communication network, called user network (UN) of the current node, configured to connect the client device to said user network (UN) and, via the core network, give it access to the communication service, characterized in that, said current node being configured, upon expiry of a period of inactivity during which no client device has connected to said user network (UN), to enter into a partially deactivated state, comprising a partial deactivation of said radios, according to which one of said radios among the first and second radios remains active, said apparatus is configured to implement:
upon receipt of a communication request by the current node on one of said first and second radios, reactivation of the other radio, when said current node is in the partially deactivated state, and
when the deactivated state of the current node comprises a deactivation of the first radio and when it has been determined, at least as a function of the received communication request, that a connection of the current node to the core network is required to process said communication request, and following a connection failure of the current node to said at least one neighbor node, triggering a reactivation of the at least one neighbor node by the current node sending a discovery request on the radio remaining active of said at least one neighbor node.

9. A node device (NG, NEL, NEH), called current node, of a first wireless communication network (WN), comprising at least one other node device, called neighbor node, said current node comprising a first radio hosting at least a first access point to a first wireless communication network of said current node, called core network (CN), and a second radio hosting at least one second access point to a second wireless communication network of the current node, called user network (UN), configured to connect the client device to the current node and, via the core network, give it access to the communication service, characterized in that said current node comprises an apparatus for managing an activation state of the node device according to claim 8.

10. A communication system(S) comprising at least two node devices according to claim 9, of a first wireless communication network, called core network (CN), configured to provide a communication service to a client device, said system comprising a client device (UT) able to connect to a second wireless communication network (UN), called user network, of at least one of said node devices to access said communication service.

11. A non-transitory computer-readable storage medium comprising program instructions stored thereon for causing a computer to perform a method according to claim 1.
